(19) United States
(12) Patent Application Publication
(10) Pub. No.: US 2009/0024950 A1
(43) Pub. Date: Jan. 22, 2009

(54) Printer Driver Interface and Methods

(75) Inventors: David Salgado, Victor, NY (US); Jeremy Griffith, East Rochester, NY (US)

Correspondence Address: Prass LLP, 2661 Riva Road, Building 1000, Suite 1044, Annapolis, MD, 21401, US

(73) Assignee: XEROX CORPORATION, Stamford (CT)

(21) Appl. No.: 11/778,883

(22) Filed: Jul. 17, 2007

(51) Int. Cl. G06F 3/048

(52) U.S. Cl. 715/772

(57) ABSTRACT

Disclosed are methods of displaying status information in a printer driver interface, and corresponding apparatus and computer-readable medium. The embodiments display a printer driver interface, the printer driver interface including selectable document settings, and display a status bar on the printer driver interface, the status bar displaying iconic status indicators, wherein the iconic status indicators include status indicators each conveying status information on a printer consumable.

### CROSS REFERENCE TO RELATED APPLICATIONS

This application is related to the following U.S. applications, filed simultaneously with this application, and the disclosures of which are incorporated by reference herein in their entirety: 1) Attorney Docket No. 056-0001; 2) Attorney Docket No. 056-0002; 3) Attorney Docket No. 056-0005; and 4) Attorney Docket No. 056-0007.

### BACKGROUND

Disclosed herein are methods for displaying a printer driver interface, and in particular to such methods that display iconic status information, as well as corresponding apparatus and computer-readable medium.

Image forming devices such as printers, copiers and multi-function devices provide users the ability to print from a device such as a desktop or laptop computer, a handheld computer, or other electronic devices, to a printer connected to the device. The electronic devices may be stand alone devices, or may be connected in a network, such as in a business computing environment, which may include one or more printers.

In order for a printer to interface with and function with the computer to which it is connected, a printer driver can typically be installed on the computer. A printer driver is software which controls the printer from the computer. The printer driver may include a user interface which may be typically accessed by a user through an operating system or an application program, such as a word processing program, a spreadsheet program, or other types of programs, and viewed on a display.

When a user is getting ready to print, the status of the printer and the status of printer consumables are important information that will help the user to make efficient and useful printing decisions. For example, it would be useful if the user were presented in the printer driver interface with information such as whether the printer is ready to print or has a problem like a paper jam or the like, and the status of printer consumables, such as toner, ink, paper in individual trays, and the like. Current printer driver interfaces do not provide this functionality.

### SUMMARY

According to aspects of the embodiments, there is provided methods of displaying status information in a printer driver interface, and corresponding apparatus and computer-readable medium. The methods include displaying a printer driver interface, the printer driver interface including selectable document settings, and displaying a status bar on the printer driver interface, the status bar displaying iconic status indicators, wherein the iconic status indicators include status indicators, each conveying status information on a printer consumable.

### BRIEF DESCRIPTION OF THE DRAWINGS

FIG. 1 illustrates a block diagram of a system for controlling a printer;

FIG. 2 illustrates a block diagram of a system for controlling a printer;

FIG. 3 illustrates a diagram of a printer user interface;

FIG. 4 illustrates a diagram of a printer user interface;

FIG. 5 illustrates a diagram of a printer user interface;

FIG. 6 illustrates a diagram of a printer user interface; and

FIG. 7 illustrates a flowchart of a method for displaying status information in a printer interface.

### DETAILED DESCRIPTION

Aspects of the embodiments disclosed herein relate to methods for displaying status information in a printer driver interface, and corresponding apparatus and computer-readable medium. The embodiments allow a user to easily view iconic status information concerning the printer on the printer driver interface. The iconic status information may concern printer consumables, such as toner, paper, and the like, and may include status information on the printer.

The embodiments include methods for displaying status information in a printer driver interface. The methods include displaying a printer driver interface, the printer driver interface including selectable document settings, and displaying a status bar on the printer driver interface, the status bar displaying iconic status indicators, wherein the iconic status indicators include status indicators, each conveying status information on a printer consumable.

The embodiments further include an apparatus displaying status information in a printer driver interface. The apparatus includes a memory that stores print driver instructions, and a processor that executes the print driver instructions to cause display of the printer driver interface upon receipt of a print command from a user by displaying the printer driver interface, the printer driver interface including selectable document settings, and displaying a status bar on the printer driver interface, the status bar displaying iconic status indicators, wherein the iconic status indicators include status indicators each conveying status information on a printer consumable.

The embodiments further include a computer-readable medium that includes a computer-usable data carrier storing instructions, the instructions the instructions when executed by a computer causing the computer to display status information in a printer driver interface by displaying the printer driver interface, the printer driver interface including selectable document settings, and displaying a status bar on the printer driver interface, the status bar displaying iconic status indicators, wherein the iconic status indicators include status indicators each conveying status information on a printer consumable.

The term “application” in the disclosed embodiments refers to a program designed for end users of a computing device, such as a word processing program, a database program, a browser program, a spreadsheet program, a gaming program, and the like. An application is distinct from systems programs, which consist of low-level programs that interact with the computing device at a very basic level, such as an operating system program, a compiler program, a debugger program, programs for managing computer resources, and the like.

A printer “document setting” in the disclosed embodiments refers to a setting of an attribute of a document to be printed that can be selected and saved by the user. Examples of printer document settings are settings for stapled or not stapled, paper size, watermark, paper tray, print resolution, and color printing or black and white printing. A printer “default setting” in the disclosed embodiments refers to one or more document settings that are saved as a default setting to be automatically used for printing unless manually changed at the time of printing. A printer “document default setting” in the disclosed embodiments refers to one or more document settings that are saved to be automatically used for printing the particular document unless the settings are manually changed at the time of printing.

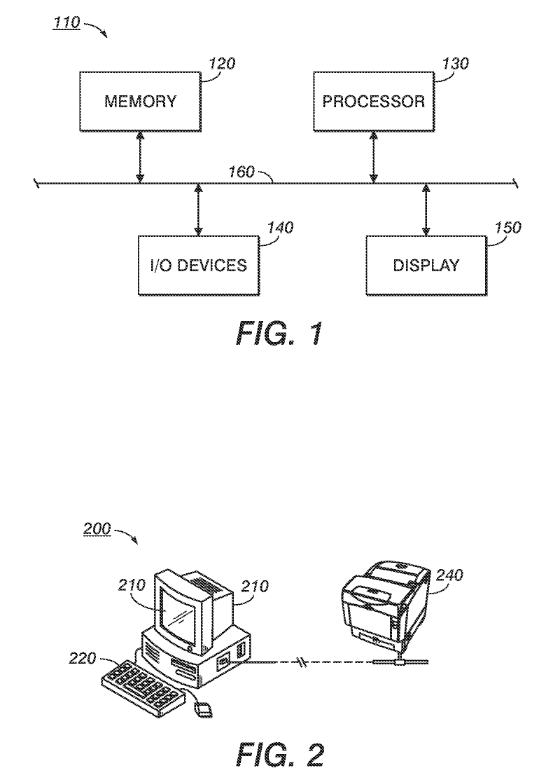

FIG. 1 illustrates a diagram of a system 110. The system 110 may be embodied within devices such as a desktop computer, a laptop computer, a handheld computer, a handheld communication device, or another type of computing device, or the like. The system 110 may include a memory 120, a processor 130, input/output devices 140, a display 150 and a bus 160. The bus 160 may permit communication and transfer of signals among the components of the computing device 110.

Processor 130 may include at least one conventional processor or microprocessor that interprets and executes instructions. The processor 130 may be a general purpose processor or a special purpose integrated circuit, such as an ASIC, and may include more than one processor section. Additionally, the system 110 may include a plurality of processors 130.

Memory 120 may be a random access memory (RAM) or another type of dynamic storage device that stores information and instructions for execution by processor 130. Memory 120 may also include a read-only memory (ROM) which may include a conventional ROM device or another type of static storage device that stores static information and instructions for processor 130. The memory 120 may be any memory device that stores data for use by system 110.

Input/output devices 140 (I/O devices) may include one or more conventional input mechanisms that permit a user to input information to the system 110, such as a microphone, touchpad, keypad, keyboard, mouse, pen, stylus, voice recognition device, buttons, etc., and output mechanisms such as one or more conventional mechanisms that output information to the user, including a display, one or more speakers, a storage medium, such as a memory, magnetic or optical disk, disk drive, a printer device, etc., and/or interfaces for the above. The display 150 may typically be an LCD or CRT display as used on many conventional computing devices, or any other type of display device.

The system 110 may perform functions in response to processor 130 by executing sequences of instructions or instruction sets contained in a computer-readable medium, such as, for example, memory 120. Such instructions may be read into memory 120 from another computer-readable medium, such as a storage device, or from a separate device via a communication interface, or may be downloaded from an external source such as the Internet. The system 100 may be a stand-alone system, such as a personal computer, or may be connected to a network such as an intranet, the Internet, or the like.

The memory 120 may store instructions that may be executed by the processor to perform various functions. For example, the memory may store printer driver instructions to allow the system to perform various printing functions in association with a particular printer connected to the system. The printer driver instructions are typically unique to each specific type of printer, and the system 110 may store a plurality of print drivers each for a different printer.

FIG. 2 illustrates a system 200. The system 200 includes a computer 210, which includes the elements of system 110, including the memory 120, the processor 130, I/O devices 140 and a display 150. The computer 210 could be a standard personal computer, or could be another type of computing device such as a handheld computer, a phone, a laptop computer, or the like.

The system 200 may also include a keyboard 220 functioning as an input device. The keyboard may be replaced or supplemented by the input devices as illustrated in FIG. 1.

The system 200 may also include a display 230 functioning as an output device for displaying images generated or received by the computer 210, corresponding to display 150 shown in FIG. 1. The display 230 may display images to be viewed by a user, such as various application programs, a user interface (UI), text, photographic images, or the like. For example, the display may generate a user interface in response to a print driver stored in memory 120, such as a user interface for the print driver. The print driver could also be stored in a memory in a network that the computer 210 is connected to, such as in a network server.

The system 200 may have a printer 240 connected thereto for printing data such as images, text, or the like in response to a user directing the computer 210 to print, for example. In response to such a print command, the processor will typically cause the print driver to communicate with the printer to perform the needed printing.

The system 200 may be connected to a network, such as such as an intranet, the Internet, a wireless network, or the like. In addition, the system 200 may be connected to a plurality of printers such as printer 240. The plurality of printers may be of a same printer type or of varying printer types.

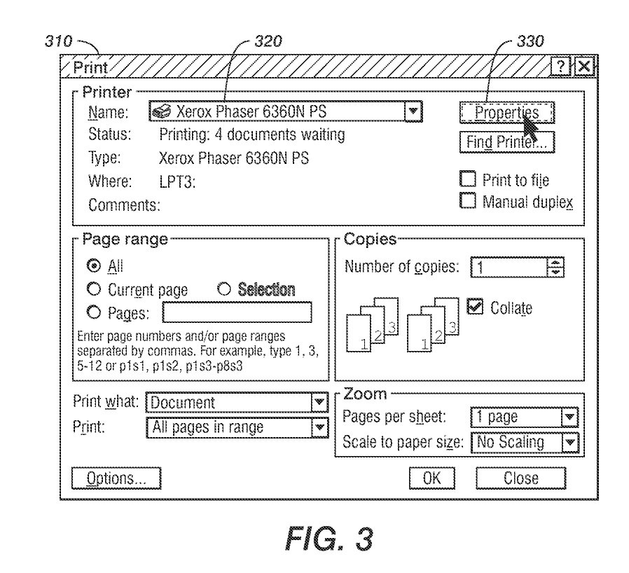

FIG. 3 illustrates a printer user interface 310 that may be displayed on a display of computer 210. The printer user interface 310 may be invoked and displayed when a user selects a print function on the computer 210, typically using an input device such as keyboard 220, for example. The user may typically select a printer in the printer selection area 320. The user will typically be able to select from all printers for which a print driver has been loaded into memory of the computer 210. In the case of the FIG. 3 example, the user can select from printers through the use of a drop-down menu, and printers other than the one shown may be selected. Upon selection of properties 330, a further printer user interface 410 will be displayed. The user may also be able to cause display of the printer user interface 410 in other ways, such as selecting the corresponding printer such as through the control panel, and then selecting printing preferences, although any way of reaching this interface could be used. The print user interfaces 310, 410 are example interfaces, and other print user interfaces may be used.

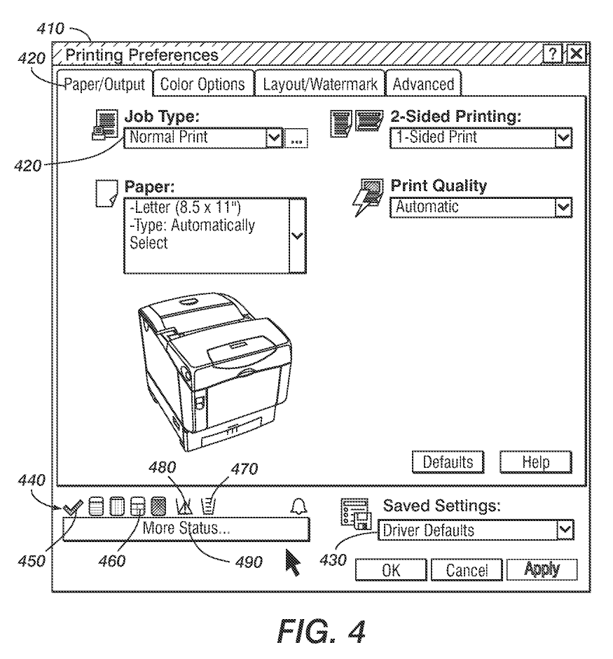

FIG. 4 illustrates an exemplary diagram of a further printer user interface 410 that may be displayed on a display of computer 210, for example. The printer user interface 410 includes one or more printer document settings 420 that may be selected and set by the user. The document settings 420 are settings of an attribute of a document to be printed. The user may select and save different printer document settings 420 prior to printing. For example, the printer document settings may include paper, output, special pages, layout, watermark, image options, advanced, and so forth. The paper setting may allow selection of a paper size, a paper color, or other paper features. The output setting may include a selection of 1 or 2 sided printing, a print quality, a destination, or the like.

A layout setting may allow selection of page layout features such as portrait, landscape, number of sheets per page, or the like. A watermark setting may allow selection of watermark features such as draft, confidential, print in background, or the like. An image options setting may allow selection of features such as application reduce/enlarge, PostScript pass-through, mirrored output, or the like. An advanced setting may allow selection of features such as booklet layout, image color management, or the like.

The printer document settings shown and described herein are only examples. Any printer document settings may be used including those that are selectable by the user.

The printer user interface 410 also shows printer default setting 430 that may be saved by a user. After selecting document settings 420, the user may save the printer document settings 420 for use as a printer default setting. This may be accomplished with the printer default settings 430. In the example shown in FIG. 4, this may be done with the use of a drop-down menu, that allows saving of the selected document settings 420 as a printer default setting (driver default), as an application default setting, under a user selected name, or as a document default setting.

When the selected printer settings are saved as driver defaults, the printer settings may be used when the user selects the corresponding print driver via selection of the printer. Different types of printers have different print drivers, and selection of a particular printer for printing will open the corresponding print driver. If the document settings 420 have previously been saved as driver defaults, they may be used for printing with the corresponding printer unless the user manually changes the saved printer settings.

The user may also save the document settings 420 as a default document setting. When the document settings are saved as a default document setting, anytime the user prints from the default document with the corresponding printer, the document default setting will be used unless the user manually changes the document settings. For example, the user may save the document settings 420 as Document Default, as shown in FIG. 4. When the user prints the particular document with the corresponding printer, the default document setting will be invoked for printing. In particular, if the user, after saving the document settings 420 as default document setting, selects print when the particular document is open, a printer user interface such as printer user interface 310 may be displayed. If the user then selects OK, the printing will commence with the Document Default setting, and the document settings that were saved will be used for printing.

The embodiments may automatically provide the user with the option of saving the documents settings as a document default setting with the Document Default as shown in FIG. 4, or may use the current name of the document in providing the document default setting. For example, if the document is named March Expenses, the drop-down menu may provide the option to save as “March Expenses Default.”

Additionally, the embodiments allow the user to save document settings using a name that the user chooses. For example, the user can select any name to save document settings for later use using the dropdown menu of FIG. 4, using the Save As feature 440. The user can select a name and then invoke the saved settings for that name using the dropdown menu when printing a document.

Additionally, the embodiments allow the user to save documents settings as an application default. Then, when the user prints a document from the corresponding application, the embodiments may use the corresponding application default for printing.

Also shown in FIG. 4 is a status bar 440. The status bar 440 displays iconic status information on the printer and a plurality of consumables that the printer uses. The status information is displayed in the form of icons. Each of the icons gives a visual indication of the status of the item it represents. The status bar 440 is in an area of the printer user interface 410 separate from the document settings 420.

The status bar 440 may display a printer status 450, which may be a visual indication of the status of the printer. In the example of FIG. 4, the printer status 450 is shown as a check, indicating that the printer is “ready”. The printer status 450 will change appearance when the printer is not ready, such as changing to an X. The printer status may be in a particular color as well, such as green for ready, and red for not ready, although any particular colors or symbols may be used that convey the desired status. The symbols and colors used as icons are selected to convey the status of the item at a glance of the user.

As shown in FIG. 4, the iconic status indicators for consumables may include toner status indicators 460, each showing an iconic indication of the status of a particular toner, and paper status indicators 470, each showing the status of paper in a particular tray, for example. The consumables for which iconic status indicators may be present may include paper in individual trays, ink, toner, and the like. The status of the consumables may be a remaining level of the particular consumable, or a state, such as empty, full, or some level between.

The physical appearance of the each of the iconic status indicators may change as the consumables are used. For example, for the toner status indicators, when a particular toner is full, the corresponding icon 460 may show a full level, with a decreasing level as the toner is used. Additionally, the toner status indicators 460 may be shown on the icon each in a different color corresponding to the particular toner. Typical toner colors may be cyan, yellow, magenta and black, and the iconic toner status indicators may thus appear in these colors. The visual indications in the iconic toner status indicators allow a user to assess the level of the toner of each color at a glance.

Regarding the paper status indicators, a paper level may be show such as in FIG. 4 with paper appearing in the icon, and visually show a decreasing level as the paper is used by showing less paper in the icon. As the paper is depleted or nearly depleted in a tray, a visual indication may appear as a warning, such as the warning indicator 480. The warning indicator may be a particular visual appearance, shape and/or color to convey a warning to a user. For example, the warning indicator 480 may be a triangle with an exclamation point, as shown in FIG. 4, and may be a color such as yellow to convey a warning. Additional warning indicators could be provided, such as a warning indicator indicating printer not communicating, or bi-directional communication turned off. The warning indicators may include a message and an enablement option, such as allowing the user to enable bi-directional communication. Any warning indicators may be used.

There may also be included a More Status indicator 490, which may allow display of more detailed status information, or may allow the user to add or remove status items from the status bar 440. Additional items that could be added to the status bar in the form of iconic status indicators include output trays, a software mailbox, job storage areas, stapler, binding tape, and the like.

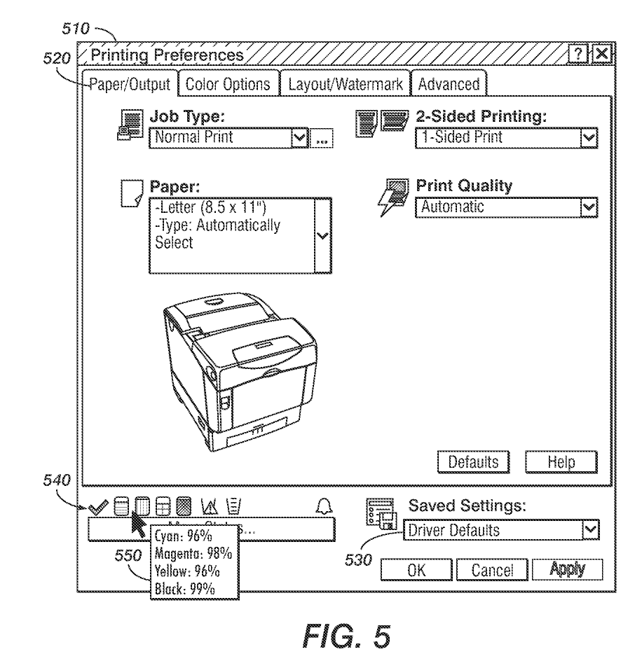

FIG. 5 illustrates an exemplary diagram of a further printer user interface 510. The printer user interface 510 includes various document settings 520 that may be saved by the user as one or more default settings 530, and iconic status indicators 540, as explained in conjunction with FIG. 4. Additionally illustrated is detailed status information 550, which may be displayed in a pop-up window, when a user places a cursor above one of the iconic status indicators 540, for example. Detailed status information conveys more detailed information than is conveyed by the iconic status indicators.

In the embodiment shown in FIG. 5, the detailed status information 550 indicates a remaining amount of toner for each of the various colored toners used, in this case on a percentage basis. In particular, in this example, the detailed status information 550 indicates a remaining level of the toners as cyan 96%, magenta 98%, yellow 96% and black 99%. Any detailed status information could be displayed, such as empty or 0%, or a warning indicator could be displayed, when the toner level is approaching or at a low or empty level.

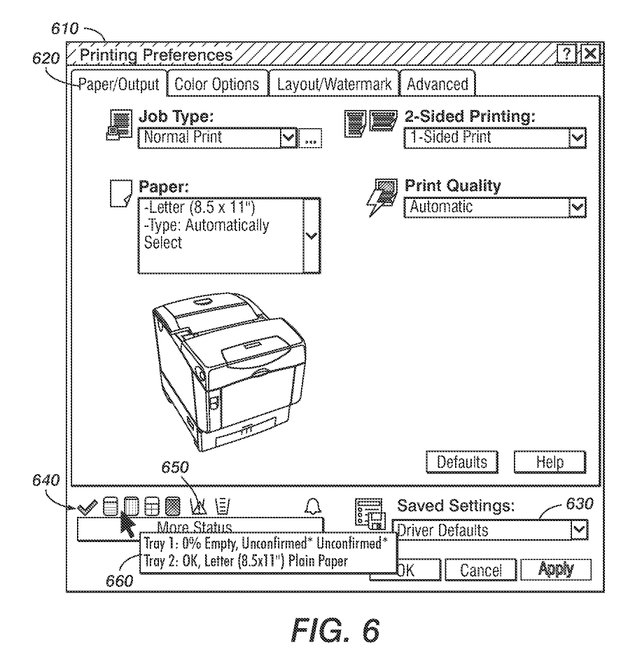

FIG. 6 illustrates an exemplary diagram of a further printer user interface 610. The printer user interface 610 includes various document settings 620 that may be saved by the user as one or more default settings 630, iconic status indicators 640, warning indicator 650, and detailed status information 660, as explained in conjunction with FIG. 4. In this embodiment, the detailed status information 660 displays detailed status information about trays 1 and 2, which is displayed when the user places a cursor over one of the tray icons. In particular, the detailed status information indicates that tray 1 is empty and that tray 2 is OK and contains 8.5×11″ plain paper. These are examples of detailed status information that could be provided, but other detailed status information could also be displayed. For example, detailed status information may be provided indicating the status of the printer, such as ready, a problem such as a paper jam, that toner is low, and the like.

Embodiments may display the detailed status information for an individual iconic status indicator 540, 640 when the user places a cursor over the individual iconic status indicator, may display detailed status information for all iconic status indicators of a particular type whenever a cursor is placed over any iconic status indicators of that type, or may display the detailed status information for all of the iconic status indicators whenever the cursor is placed over any one of the iconic status indicators. For example, when the user places a cursor over one of the toner iconic status indicators, the detailed information for all of the toner iconic status indicators may be displayed as shown in the detailed status indicator 550. Alternatively, if the user places the cursor over a cyan toner iconic status indicator, only the detailed status information for the cyan toner could be displayed.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

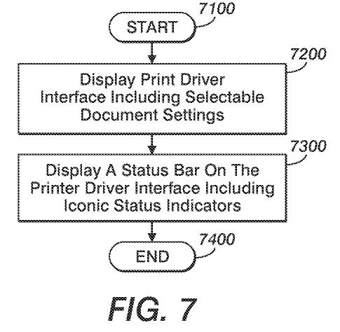

FIG. 7 illustrates a flowchart of a method of displaying status information in a printer driver interface. The method starts at 7100. At 7200, the printer driver interface is displayed including selectable document settings. At 7300, a status bar is displayed on the printer driver interface, the status bar iconic status indicators each displaying status information on a printer consumable. At 7400, the method ends.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of displaying status information in a printer driver interface, comprising:
displaying the printer driver interface, the printer driver interface including selectable document settings; and
displaying a status bar on the printer driver interface, the status bar displaying iconic status indicators, wherein the iconic status indicators include status indicators each conveying status information on a printer consumable.

2. The method of claim 1, wherein the iconic status indicators further include a status indicator conveying status information on a printer corresponding to the printer driver interface.

3. The method of claim 1, further comprising changing an appearance of the iconic status indicators as the corresponding printer consumable is depleted.

4. The method of claim 1, further comprising displaying a detailed status window corresponding to at least one of the iconic status indicators, the detailed status window containing more detailed status information than the corresponding iconic status indicator, the detailed status window being displayed in response to a user indication.

5. The method according to claim 4, wherein the detailed status information includes a remaining percentage of the corresponding printer consumable.

6. The method of claim 4, wherein the detailed status information includes a paper tray current capacity, a paper size, and a paper type.

7. The method of claim 1, further comprising displaying a warning indication indicating a warning condition on at least one of the iconic status indicators.

8. The method of claim 1, further comprising displaying additional iconic status indications as requested by a user.

9. An apparatus for causing display of status information in a printer driver interface, comprising:
a memory that stores print driver instructions; and
a processor that executes the print driver instructions to cause display of the printer driver interface upon receipt of a print command from a user by:
displaying the printer driver interface, the printer driver interface including selectable document settings; and
displaying a status bar on the printer driver interface, the status bar displaying iconic status indicators, wherein the iconic status indicators include status indicators each conveying status information on a printer consumable.

10. The apparatus of claim 9, wherein the iconic status indicators further include a status indicator conveying status information on a printer corresponding to the printer driver interface.

11. The apparatus of claim 9, wherein the processor further causes display of the printer driver interface by changing an appearance of the iconic status indicators as the corresponding printer consumable is depleted.

12. The apparatus of claim 9, wherein the processor further causes display of the printer driver interface by displaying a detailed status window corresponding to at least one of the iconic status indicators, the detailed status window containing more detailed status information than the corresponding iconic status indicator, the detailed status window being displayed in response to a user indication.

13. The apparatus of claim 12, wherein the detailed status information includes a remaining percentage of the corresponding printer consumable.

14. The apparatus of claim 12, wherein the detailed status information includes a paper tray current capacity, a paper size, and a paper type.

15. The apparatus of claim 9, wherein the processor further causes display of the printer driver interface by displaying a warning indication indicating a warning condition on at least one of the iconic status indicators.

16. The apparatus of claim 9, wherein the processor further causes display of the printer driver interface by displaying additional iconic status indications as requested by a user.

17. A computer-readable medium, comprising:
a computer-usable data carrier storing instructions, the instructions when executed by a computer causing the computer to display status information in a printer driver interface by:
displaying the printer driver interface, the printer driver interface including selectable document settings; and
displaying a status bar on the printer driver interface, the status bar displaying iconic status indicators, wherein the iconic status indicators include status indicators each conveying status information on a printer consumable.

18. The computer-readable medium of claim 17, wherein the iconic status indicators further include a status indicator conveying status information on a printer corresponding to the printer driver interface.

19. The computer-readable medium of claim 17, wherein the instructions further comprise instructions causing the computer to display status information in a printer driver interface by changing an appearance of the iconic status indicators as the corresponding printer consumable is depleted.

20. The computer-readable medium of claim 17, wherein the instructions further comprise instructions causing the computer to display status information in a printer driver interface by:
displaying a detailed status window corresponding to at least one of the iconic status indicators, the detailed status window containing more detailed status information than the corresponding iconic status indicator, the detailed status window being displayed in response to a user indication.
